(19) United States
(12) Patent Application Publication
(10) Pub. No.: US 2015/0300919 A1
(43) Pub. Date: Oct. 22, 2015

(54) Method for Producing a Sensor Element

(71) Applicants: Johannes ANTE, Regensburg (DE); Markus HERRMANN, Regensburg (DE); Andreas OTT, Steinsberg (DE); Willibald Reitmeier, Hohenschambach (DE); Manfred WEIGL, Sinzing/Viehhausen (DE); Andreas WILDGEN, Nittendorf (DE)

(72) Inventors: Johannes ANTE, Regensburg (DE); Markus HERRMANN, Regensburg (DE); Andreas OTT, Steinsberg (DE); Willibald Reitmeier, Hohenschambach (DE); Manfred WEIGL, Sinzing/Viehhausen (DE); Andreas WILDGEN, Nittendorf (DE)

(21) Appl. No.: 14/399,768

(22) PCT Filed: May 2, 2013
(86) PCT No.: PCT/EP2013/059090

§ 371 Date: Nov. 7, 2014

(30) Foreign Application Priority Data
May 9, 2012 (DE) 10 2012 207 761.8

(51) Int. Cl. G01M 15/10; G01N 27/02

(52) U.S. Cl. CPC G01M 15/102; G01N 27/02

(57) ABSTRACT

A method for producing a sensor element for a sensor for detection of substances contained in a gas flow includes: providing a ceramic carrier; and producing an open measurement electrode, arranged on the carrier and exposed to the gas flow. The open measurement electrode is produced by: a combined printing technique from a cermet base print for a base layer of a ceramic-platinum cermet, arranged on the carrier, and a platinum upper printing for a cover layer of sintered platinum arranged on the base layer.

### CROSS-REFERENCE TO RELATED APPLICATIONS

This is a U.S. national stage of application No. PCT/EP2013/059090, filed on 2 May 2013, which claims priority to the German Application No. DE 10 2012 207 761.8 filed 9 May 2012, the content of both incorporated herein by reference.

### BACKGROUND OF THE INVENTION

1. Field of the Invention

The present invention relates to a method for producing a sensor element for a sensor for the detection of substances contained in a gas flow, in particular soot particles in the exhaust gas of an internal combustion engine, having a carrier made of ceramic and an open measurement electrode, which is arranged on the carrier and is exposed to the gas flow.

2. Related Art

Such a sensor element is known, and is described for example in DE 10 2010 044 308 A1. It is used, in particular, as a soot sensor in the exhaust gas system of diesel engines. With the aid of the measurement electrode, for example by a resistance, capacitance or impedance measurement, the level of soot particles contained in the exhaust gas flow is detected and delivered in the form of electrical signals to a control device of the internal combustion engine.

The measurement electrode is in this case formed as an open electrode exposed to the gas flow, and has for example the shape of an interdigital electrode (comb electrode). It consists of fine conductive tracks which are applied, in particular printed, onto a carrier made of ceramic. The carrier is preferably formed as an elongate element in the form of a plate and consists, as mentioned, of a ceramic material such as aluminum oxide. The conductive track structure of the measurement electrode is provided with corresponding conductive track connections, which lead to corresponding connection contacts.

Such sensor elements of particle sensors are furthermore provided with heaters in order to be able to periodically clean the electrode exposed to the gas flow, on which the particles contained in the gas flow deposit increasingly as the measurement time increases. To this end, heating of the measurement electrode, and therefore combustion of the deposited particles, which are thereby removed from the measurement electrode, are carried out.

With an increasing measurement time, however, solid, inorganic and incombustible exhaust gas components are also deposited on these open measurement electrodes, which leads to the open measurement electrodes being covered with nonconductive substances and therefore electrically and mechanically insulated against access of the particles to be measured (against soot access). In this way, the measurement function of the measurement electrodes is lost. In tests on an engine test rig, full coverage of the measurement electrodes has been identified after operation for 2000-3000 hours.

Another problem in the case of such sensor elements consists in ensuring reliable and permanent bonding of the measurement electrode on the carrier made of ceramic material. In the case of measurement electrodes made of pure platinum, for example, it has been shown that although they have little or no deposits of undesired incombustible exhaust gas components over a relatively long period of time (up to 3000 operating hours), but they do not have permanent bonding on the ceramic carrier. This applies, in particular, to pure Pt thick-film prints (sintered platinum without glass components and without ceramic components).

A sensor element of the type described in the introduction is known from U.S. Pat. No. 5,698,267 A. The element comprises a base layer made of a ceramic-platinum cermet, on which there is a platinum cover layer. This cover layer is applied by impregnation of the base layer with a liquid platinum compound, evaporation of the solvent, and a heat treatment in order to decompose the compound and obtain the pure metal.

GB 2 081 905 A discloses a sensor element which comprises a measurement electrode provided with a porous cover layer. The measurement electrode is composed of a base layer made of a ceramic-platinum cermet and a platinum cover layer, the cover layer being applied by a coating technique such as sputtering, ion plating or vacuum evaporation.

### SUMMARY OF THE INVENTION

An object of the present invention is to provide a method of the type mentioned in the introduction, with which it is possible to produce a measurement electrode which is distinguished by particularly good bonding on the carrier while avoiding undesired deposits.

This object is achieved according to the invention by a method as set forth herein.

By the combination, according to the invention, of a cermet base layer and a platinum cover layer, an optimum is achieved in bonding on the ceramic carrier and in protection against deposits. It has been shown that the cermet layer has very good bonding on the ceramic carrier. However, since such a layer is also associated with a high tendency toward the deposition of exhaust gas particles (ash, sulfur, metal oxides, etc.), it is not very suitable as a cover layer, or layer for contact with the gas flow. In this case, tests have shown that strong deposits occur after about 2000 operating hours.

On the other hand, a layer of pure platinum is suitable as the cover layer, or contact layer. Such a layer has good protection against undesired deposits.

Cermet, or metal ceramics, refers to a group of materials consisting of two separate phases (a metallic component and a ceramic component), which differ from one another in terms of certain properties, in particular hardness, melting point. An example of a ceramic-platinum cermet is one based on silicide, such as an MoSi₂-Pt cermet.

The measurement electrode is formed from a cermet base print and a platinum upper print. The measurement electrode is therefore produced, according to the invention, by a combined printing technique, an increase in the bonding of the measurement electrode on the ceramic carrier and minimization of undesired deposits on the measurement electrode thereby being achieved.

Preferably, the base layer (bonding promoter layer) is produced from a ceramic-platinum printing paste.

The sensor element produced according to the invention is used, in particular, in all sensors having open sensor contact materials, preferably in a soot sensor. The measurement electrode is preferably formed as an interdigital electrode (comb electrode).

In one refinement of the invention, the measurement electrode is formed in order to apply an alternating voltage. Undesired deposits can be further minimized by having an alternating voltage applied during operation of the measurement electrode.

Alternatively, a glass-bound platinum paste may also be used as the base layer.

### BRIEF DESCRIPTION OF THE DRAWINGS

The invention will be explained in detail below with the aid of an exemplary embodiment in conjunction with the drawings, in which:

FIG. 1 shows a schematic plan view of the sensor element of an interdigital sensor; and

FIG. 2 shows an enlarged partial section through the sensor, element of FIG. 1.

### DETAILED DESCRIPTION OF THE PRESENTLY PREFERRED EMBODIMENTS

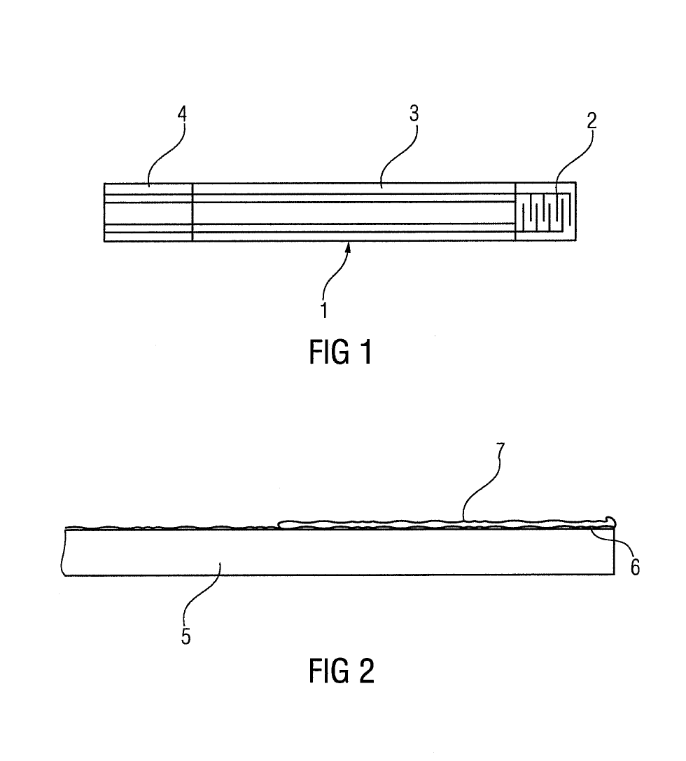

FIG. 1 schematically shows a plan view of the sensor element 1 of an interdigital sensor, which is, for example, a soot sensor. In the case of this sensor element, the measurement electrode 2 is formed as an interdigital electrode, or comb electrode. It is formed at one end of the associated carrier 5 of the sensor element. Corresponding conductive tracks of the measurement electrode 2 extend over a region 3, provided with insulation, into a contact region 4.

The measurement electrode 2 is formed as an open electrode exposed to the gas flow, for example of an exhaust gas system of a diesel engine. The corresponding conductive tracks are applied onto the carrier 5 represented in FIG. 2. In detail, the measurement electrode 2 is in this case composed of a cermet base print 6, which is produced from a ceramic-platinum printing paste, and a platinum upper print 7. The measurement electrode 2 is therefore produced by a combined printing technique. An increase in the bonding of the measurement electrode on the ceramic carrier is achieved by the cermet base print, while the platinum upper print ensures minimization of undesired deposits on the measurement electrode.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-5. (canceled)

6. A method for producing a sensor element for a sensor for detection of substances contained in a gas flow, the method comprising:
providing a ceramic carrier (5); an
producing an open measurement electrode (2), arranged on the carrier (5) and exposed to the gas flow, the open measurement electrode being produced by:
a combined printing technique from a cermet base print (6) for a base layer of a ceramic-platinum cermet, arranged on the carrier (5), and
a platinum upper printing (7) for a cover layer of sintered platinum arranged on the base layer.

7. The method as claimed in claim 6, further comprising producing the base layer from a ceramic-platinum printing paste.

8. The method as claimed in claim 6, further comprising producing the measurement electrode (2) as an interdigital electrode.

9. The method as claimed in claim 6, further comprising producing the measurement electrode (2) so that it is configured to be applied with an alternating voltage.

10. The method as claimed in claim 6, wherein the detection of substances contained in a gas flow comprises detection of soot particles in the exhaust gas of an internal combustion engine.
